(19) United States
(12) Patent Application Publication
(10) Pub. No.: US 2014/0123761 A1
(43) Pub. Date: May 8, 2014

(54) Systems and Methods to Determine and Monitor Changes in Rail Conditions

(71) Applicant: Board of Regents of the University of Nebraska, (US)

(72) Inventors: Joseph A. Turner, Lincoln, NE (US); Christopher Kube, Lincoln, NE (US)

(73) Assignee: Board of Regents of the University of Nebraska, Lincoln, NE (US)

(21) Appl. No.: 13/848,100

(22) Filed: Mar. 21, 2013

Related U.S. Application Data
(60) Provisional application No. 61/794,534, filed on Mar. 15, 2013.
(60) Provisional application No. 61/613,683, filed on Mar. 21, 2012.

(51) Int. Cl. G01N 29/04

(52) U.S. Cl. CPC G01N 29/04
USPC 73/628

(57) ABSTRACT

The embodiments disclosed herein relate to various systems and methods for determining the residual stress in polycrystalline materials.

### CROSS-REFERENCE TO RELATED APPLICATION(S)

This application claims priority from U.S. Provisional Application 61/794,534, filed Mar. 15, 2013, and entitled “Systems and Methods to Determine and Monitor Changes in Rail Conditions, as well as U.S. Provisional Application 61/613,683, filed Mar. 21, 2012, and entitled “Method to Determine Residual Stress in Polycrystalline Materials,” which is hereby incorporated herein by reference in its entirety.

### FIELD OF THE INVENTION

The present application relates generally to systems and methods for determining and monitoring changes in rail conditions, including conditions related to stress. In particular, the embodiments relate to systems and methods for measuring residual rail stress over large regions of rail track to mitigate stress-related issues, such as rail breaks and rail buckling.

### BACKGROUND OF THE INVENTION

For purposes of this application, the exemplary embodiments of the system and method (or “system”) is discussed in reference to polycrystalline materials, but the system is applicable to any heterogeneous material such as paracrystalline materials. A polycrystalline material is a material that is made of microstructure comprising many smaller crystallites, or grains, with varying orientation. The variation in direction of the grains, known as texture, can be random or directed depending on growth and processing conditions. The grains also vary in size, deformation (elongation), and void spaces between grains, or porosity.

A polycrystalline material includes almost all common metals and many ceramics. A polycrystalline material is a structure of a solid, for example, steel or brass, that when cooled form liquid crystals from differing points within the material.

One example of a polycrystalline material is steel. For exemplary purposes, the system is discussed in reference to steel in the form of railroad rail, but the system is applicable to any material in any form or size or shape for which material properties are desired to be determined and monitored over time such as to assess conditions of stress and defects.

Previous studies have sought to develop methods of measuring longitudinal stress. Longitudinal stress is a problem over large regions of rail track. Stress is a measure of force per unit area, typically expressed in pound-force per square inch (psi). The term “longitudinal” means “along the major (or long) axis” as opposed to “latitudinal” which means “along the width”, transverse, or across.

Longitudinal rail stress (“LRS”) is usually related to rail contractions and expansions due to changes in temperature. Longitudinal rail stress leads to failure, which is loss of load-carrying capacity. Examples of failure include, for example, buckling and fracture. Rail experiences tensile stress in cold temperatures, which can lead to fracture or separation of a rail into two or more pieces. In hot temperatures rail experiences compression stress, which can lead to buckling or warping. Tensile stress is a stress state causing expansion (increase in volume) whereas compression stress is a stress state causing compaction (decrease in volume). It should be noted that a zero stress state is when the material does not experience any stress. Failures, among other things, cause derailments and service disruption.

The ability to measure longitudinal rail stress is a challenge in the railway industry. The presence of large regions of rail track reduces the ability of rail to expand and contract easily due to daily and seasonal temperature changes. Thus, high longitudinal stresses can develop, which, in turn, leads to possible failure.

Previous studies have developed new methods of determining longitudinal stress. However, machined metals, such as steel rails, also contain some quantity of residual stress from manufacture. Residual stress is the stress present within a material when no external load is applied to the material. Such stress is often created during manufacturing and results from thermal, geometric, or material phase changes that occur from production processes. For example, metallic parts are often created at high temperature such that casting, forging, or extrusion is possible. As the parts cool to room temperature, thermal gradients are created (e.g., the outside cools faster than the inside) and stress is generated within the part. Residual stress is sometimes a desired outcome of manufacturing. For example, surfaces that are in contact with other surfaces during use, such as a railroad wheel or rail head, are often quenched with water or oil near the end of the manufacturing process. The quenching causes the surface to cool very quickly and the quenching locks in a large amount of compressive residual stress. This stress is desirable because it decreases the likelihood of crack formation or propagation near the wheel or rail surface. Residual stress can also be detrimental because it can promote crack growth if it is not controlled. Finally, thin films created using various material deposition processes can also have high residual stresses that cause the film to deform.

At first install, a rail needs to be “set” at a certain temperature to minimize the temperature gradient (minimizing LRS) during typical extreme weather days at that location. For example, in some locations on an extreme day, the temperature outside can range from 20° F. in the morning hours to 100° F. in mid-afternoon. Installing the rail at a temperature of 80° F. will only result in compressive stresses proportional to a 20° F. temperature change. If the rail was installed at 40° F. the temperature change of 60° F. will generate much higher compressive stresses due to the larger temperature gradient. A goal is minimizing compressive stresses because a train has a much easier time passing a track with a small fracture from tension than it does with a buckled track from compression.

Thus, there is a need in the art for a means of assessing and accounting for residual stress.

### SUMMARY OF THE INVENTION

The system determines and monitors residual stress in rails. In the broadest form, the system includes an ultrasonic inspection device, an energy conversion device, an electronic test device, a computing device and a navigation device.

The system includes an ultrasonic inspection device that non-destructively assesses material conditions. A common ultrasonic inspection device includes, for example, a pulser-receiver. A pulser-receiver includes a pulser that generates electrical signals and a receiver to receive them.

An example system comprises an ultrasonic sensor unit including a plurality of ultrasonic transducers configured for operating in a pulse-echo mode (using a single transducer) or pulse-receive mode (with two or more transducers) for transmitting ultrasonic waves to a target region on or within a structural specimen and receiving ultrasonic backscatter signals responsive to the ultrasonic waves; and an evaluation module configured for receiving the ultrasonic backscatter signals, the evaluation module configured for performing signal analysis on the ultrasonic backscatter signals and determining one or more microstructural material properties of the specimen and approximating the effects of residual stress.

An example system includes a system and method with the energy conversion device attached to a railway car to implement a “rolling” system. A “rolling” system allows the system to become mobile while allowing rail conditions to be determined and monitored over large regions of rail track. It is further contemplated that a “rolling” system can be integrated with other rail measurement techniques, such as the rail deflection system developed by Shane Farritor or with defect detection vehicles, such as those used by Sperry Rail Service or Herzog Services, for example.

An example system is provided for dynamically and non-destructively determining and monitoring residual rail stress. A system for ultrasonically evaluating one or more microstructural properties of a railroad rail comprises an ultrasonic sensor unit including a plurality of ultrasonic transducers configured for operating in a pulse-echo mode for transmitting ultrasonic waves to a target region on or within a railroad rail and receiving ultrasonic backscatter signals responsive to the ultrasonic waves, the plurality of ultrasonic transducers comprising a normal incidence ultrasonic transducer configured for inducing longitudinal mode wave ultrasonic waves within the rail and at least one oblique incidence ultrasonic transducer configured for inducing shear wave mode ultrasonic waves within the rail; and an evaluation module configured for receiving the ultrasonic backscatter signals, the evaluation module configured to execute spatial variance algorithms on the ultrasonic backscatter signals and determining one or more microstructural material properties of the railroad rail.

An example system for ultrasonically determining one or more microstructural material properties of a structural specimen comprises transmitting a plurality of pulsed ultrasonic waves to a single point on a structural specimen; sensing ultrasonic backscatter signals responsive to the pulsed ultrasonic waves; selecting a time window for analyzing the ultrasonic backscatter signals; performing spatial variance calculations on the time-windowed ultrasonic backscatter signals; and determining one or more microstructural material properties of the structural specimen.

These and other advantages, as well as the invention itself, will become apparent in the details of construction and operation as more fully described and claimed below. Moreover, it should be appreciated that several aspects of the invention can be used in other applications where monitoring of stress would be desirable.

### BRIEF DESCRIPTION OF THE DRAWINGS

FIG. 1 shows a flow chart for determining and monitoring stress in rail according to one exemplary embodiment;

FIG. 2 shows a flow chart for determining and monitoring stress in rail according to another exemplary embodiment;

FIG. 3 shows a certain embodiment of a system for determining and monitoring stress in rail according to the embodiment of FIG. 2;

FIG. 4 shows a certain embodiment of a system of transducers for determining and monitoring stress in rail according to the embodiment of FIG. 2;

FIG. 5 shows example measurements taken from the system of FIG. 2 compared to a model;

FIG. 6 depicts a flow chart showing one embodiment of a system according to the embodiment of FIG. 2;

FIG. 7 depicts examples of readings given by certain embodiments of a rail measurement system;

FIG. 8 depicts exemplary backscatter results according to one embodiment;

FIG. 9 depicts exemplary backscatter results according to one embodiment;

FIG. 10 depicts theoretical backscatter stress results according to one embodiment;

FIG. 11 depicts backscatter results from multiple transducers according to one embodiment;

FIG. 12 depicts backscatter results from multiple transducers according to one embodiment;

FIG. 13 depicts backscatter results showing longitudinal residual stress according to one embodiment;

FIG. 14 depicts backscatter results showing the calculation of grain size according to one embodiment;

FIG. 15A-15D depict residual stress measurements from the present system and a variety of other methods.

### DETAILED DESCRIPTION

The exemplary embodiments of the system and method will now be described in detail with reference to certain embodiments thereof as illustrated in the accompanying drawings. In the following description, numerous specific details are set forth in order to provide a thorough understanding of the system and how it may be applied. It will be apparent, however, to one skilled in the art, that the system may be practiced without some or all of these specific details. In other instances, well-known process steps and/or structures have not been described in detail to prevent unnecessarily obscuring the system.

The various systems and methods disclosed herein relate to non-destructive techniques for analyzing materials. More specifically, various embodiments relate to various rail devices, including imaging and analysis devices and related methods and systems.

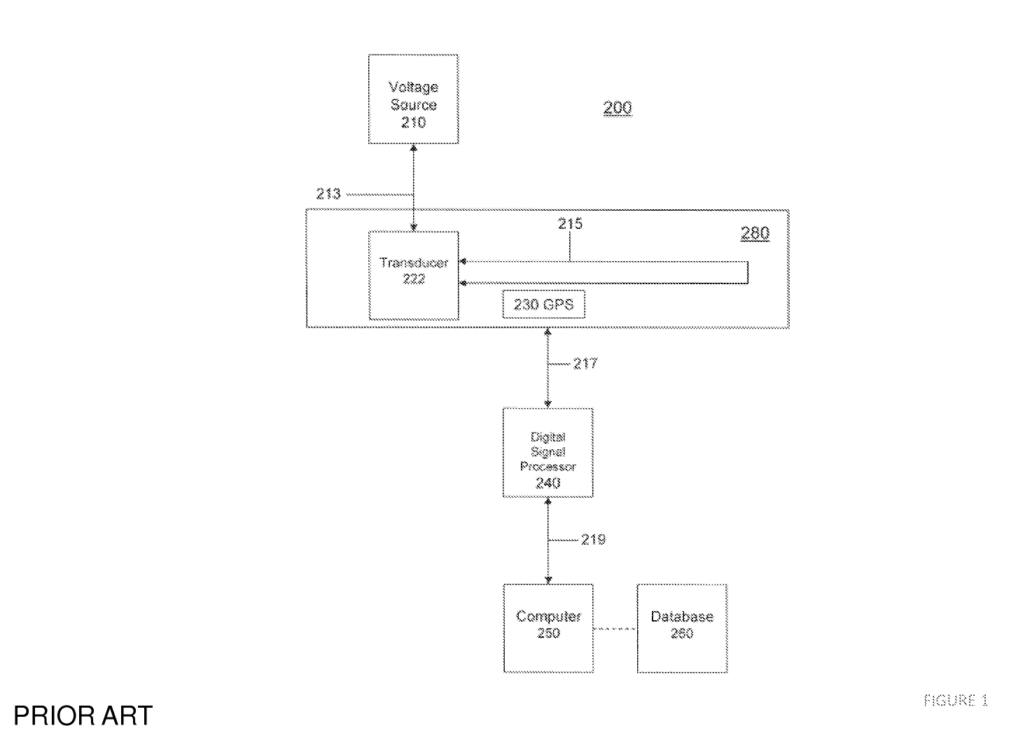

FIG. 1 is a simple block diagram 200 of a previously established system for determining and monitoring microstructural properties utilizing backscatter of an ultrasonic wave according to an exemplary embodiment of the present system. In this embodiment, a voltage source 210 generates an electrical signal that is transmitted 213 to excite transducer 222. The transducer 222 converts the electrical signal to an ultrasonic wave 215 that propagates through the specimen 280. The ultrasonic wave 215 is also received by transducer 222 utilizing a pulse-echo technique. It is further contemplated that a GPS 230 may determine position of the ultrasonic measurement 215 at specific time intervals. A digital signal processor 240 captures transmitted 217 data from the receiving ultrasonic transducers such that grain size, grain elongation, texture, and porosity may be determined. Temperature may be measured independently using, for example, an infrared temperature detector. The digital signal processor 240 provides the data via transmission 219 to the computer 250 for processing. Various source and receiving transducers can be used in concert, such that backscatter created by a single source transducer can be recorded and analyzed by a plurality of receiving transducers. Numerous signals are used to calculate a spatial variance value. The spatial variance can be calculated to determine changes in microstructure.

Changes in the microstructure are determined by examining how the theoretical spatial variance differs from the measured value used to determine the stress state in the sample, as has been previously described. The computer 250 can further include a database 260 for storage of the data. The data stored within the database 260 includes grain size, grain elongation, texture and porosity at specific intervals of time as a function of position. Data also includes grain size, grain elongation, texture and porosity which can be determined from changes in wave speed. This data is compared to a grouping of data stored within the database 260 to determine and monitor changes in the condition of the material 280.

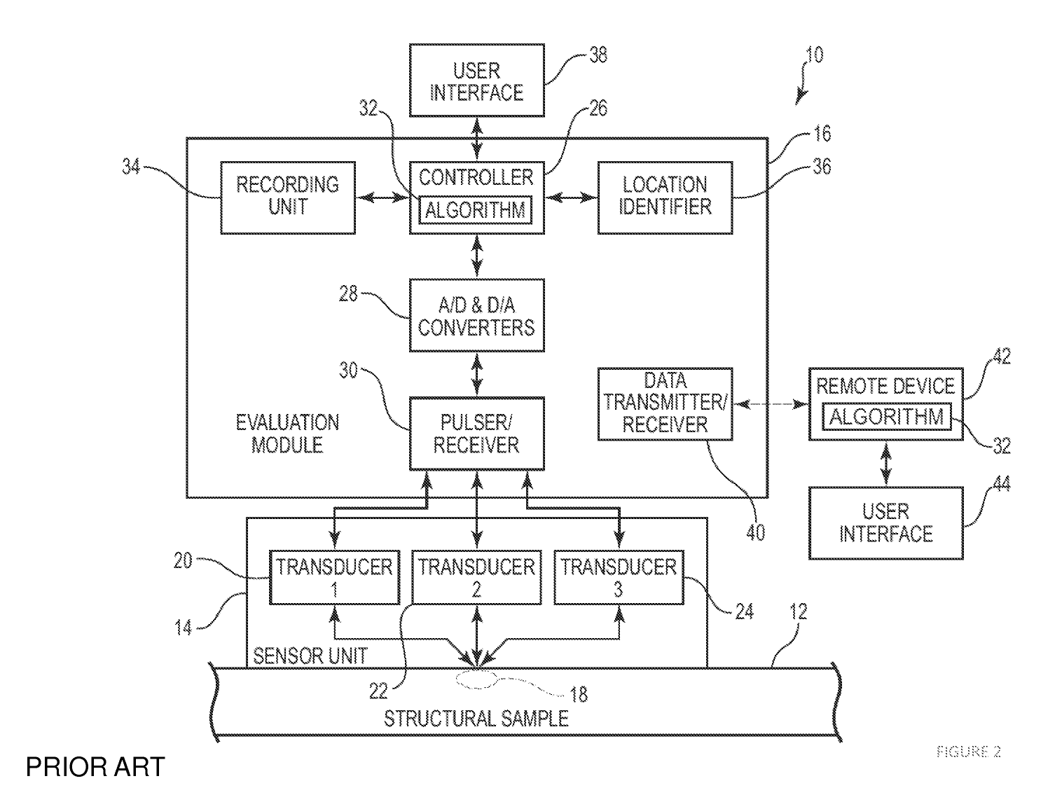

FIG. 2 provides yet another previously presented overview of certain exemplary embodiments of an analysis system. FIG. 2 is a block diagram of an exemplary system 10 for ultrasonically analyzing the microstructural properties of a structural sample 12. As shown in FIG. 2, the system 10 includes an ultrasonic sensor unit 14 and an evaluation module 16, which can be used to analyze localized stresses at one or more target locations 18 on or within the structural sample 12 by analyzing ultrasonic backscattering effects of ultrasonic waves transmitted into the sample 12. In certain embodiments, for example, the system 10 can be used for determining microstructural material properties such as stresses and strains within a railroad rail sample 12 by analyzing the ultrasonic backscattering properties of multiple ultrasonic waves transmitted from the ultrasonic sensor unit 14 to a target location 18 on or within the sample 12. The system 10 can also be used for analyzing other types of structures such as dams, bridges, buildings, storage tanks, and pressure vessels.

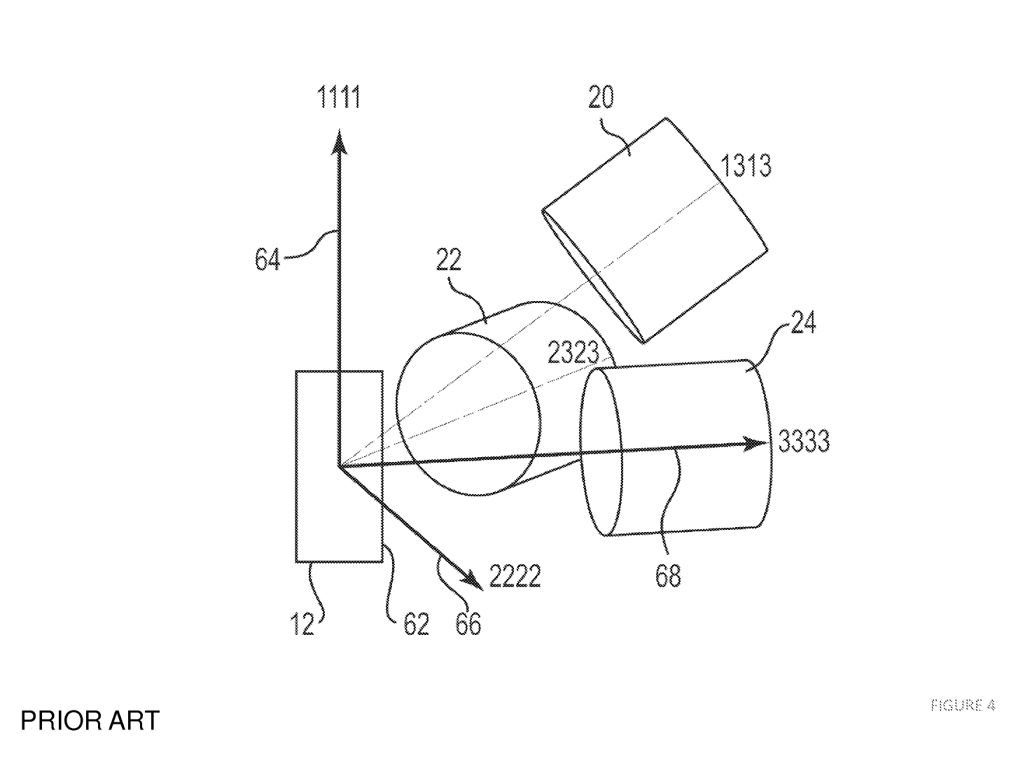

The ultrasonic sensor unit 14 includes a plurality of ultrasonic transducers 20, 22, 24 each configured to operate in a pulse-echo mode for transmitting pulsed ultrasonic waves into the structural sample 12. The resulting ultrasonic backscatter by the transmission into and reflection of these ultrasonic waves from the structural sample 12 is then sensed by the ultrasonic transducers 20, 22, 24 operating in a receive mode. In some embodiments, and as discussed further herein with respect to FIG. 4, the ultrasonic sensor unit 14 comprises two ultrasonic transducers 20, 22 configured for transmitting incident ultrasonic waves at an oblique angle relative to a surface of the structural sample 12 and a third ultrasonic transducer 24 configured for transmitting ultrasonic waves perpendicular to the surface of the structural sample 12. The number and configuration of the ultrasonic transducers 20, 22, 24 can vary in other embodiments. For example, additional ultrasonic transducers can be used for generating and transmitting oblique and normal incident ultrasonic waves into the sample 12. Furthermore, and in some embodiments, individual ultrasonic transducers are configured to operate independently in either transmitting or receiving modes, and reception of ultrasonic waves generated by one transducer in transmission mode can be received by other transducers in receiving mode. In some embodiments, an acoustic coupling medium such as water or oil or a solid couplant can be placed within the sensor unit casing to aid in acoustically coupling the ultrasonic transducers 20, 22, 24 to the structural sample 12. In some embodiments, the ultrasonic sensor unit 14 is stationary. In other embodiments, the ultrasonic sensor unit 14 is configured to move along the surface of the sample 12. In the evaluation of railroad rail, for example, the ultrasonic sensor unit 14 can be either statically coupled to the rail or configured to move along a surface of the rail such as the rail head or web.

The evaluation unit 16 is configured for evaluating the ultrasonic backscatter signals received by each of the ultrasonic transducers 20, 22, 24 operating in the receive mode. In some embodiments, the evaluation unit 16 comprises a controller 26, an analog-to-digital (A/D) and digital-to-analog (D/A) converter 28, and a pulser/receiver 30. Based on control signals from the controller 26, the pulser/receiver 30 provides electrical signals to the ultrasonic transducers 20, 22, 24 for generating pulsed ultrasonic waves in a transmission mode. The resulting ultrasonic backscatter waves received on the ultrasonic transducers 20, 22, 24 are then processed by the pulser/receiver 30, digitized, and fed back to the controller 26 for analysis by an autocorrelation algorithm 32 to determine one or more microstructural properties of the structural sample 12.

The ultrasonic backscatter data acquired from each of the ultrasonic transducers 20, 22, 24 can be stored in a recording unit 34 and/or can be relayed to one or more other devices for further processing. In some embodiments, the recording unit 34 stores the raw data obtained from each of the ultrasonic transducers 20, 22, 24, the structural data computed by the autocorrelation algorithm 32, as well as the control and operating parameters used by the system to acquire the raw and computed data.

In some embodiments, the evaluation unit 16 further includes a location identifier 36 such as a Global Positioning System (GPS) device for acquiring global location data that can be associated with backscatter data measurements obtained by the ultrasonic sensor unit 14. In some embodiments, such positioning data can be used to track the location of the ultrasonic sensor unit 14 relative to the structural sample 12, allowing backscatter data measurements acquired over time to be associated with the corresponding locations on the sample 12. In the analysis of railroad rail, for example, the global location data from the location identifier 36 can be used to associate and trend backscatter data measurements obtained along specific locations of the rail. In some embodiments, the system 10 is configured to trend this data to generate a stress gradient field of the entire rail. In contrast to structural health monitoring techniques that employ strain gauges to obtain localized measurements at discrete locations along the rail, the system 10 can be used to analyze stresses and strains within the entire structure, thus providing a better understanding of the actual condition of the structure.

A user interface 38 is configured for permitting users to view and analyze raw and processed data obtained via the ultrasonic sensor unit 14, to program the evaluation unit 16, and to perform other system functions. In certain embodiments, the user interface 38 comprises a graphical user interface (GUI) that can be used to view graphs, tables, or other visual data associated with a structure or multiple structures, either in real-time or based on data stored within the recording unit 34. In some embodiments, a data transmitter/receiver 40 is configured for wirelessly relaying data, settings, and other information back and forth between the evaluation unit 16 and a remote device 42 equipped with a remote user interface. As with user interface 38, the remote user interface 44 can also be used to view raw and processed data obtained via the ultrasonic sensor unit 14, to program the evaluation unit 16, and for performing other system functions. In some embodiments, the remote device 42 can be further configured to run an autocorrelation algorithm 32 to determine one or more characteristics (e.g., stress, strain, etc.) of the structural sample 12.

One or more components of the evaluation unit 16 and/or remote device 42 can be implemented in software, hardware, or a combination of both. In some embodiments, the systems and methods described herein can be executed as computer readable instructions on a programmable computer or processor comprising a data storage system with volatile and/or non-volatile memory.

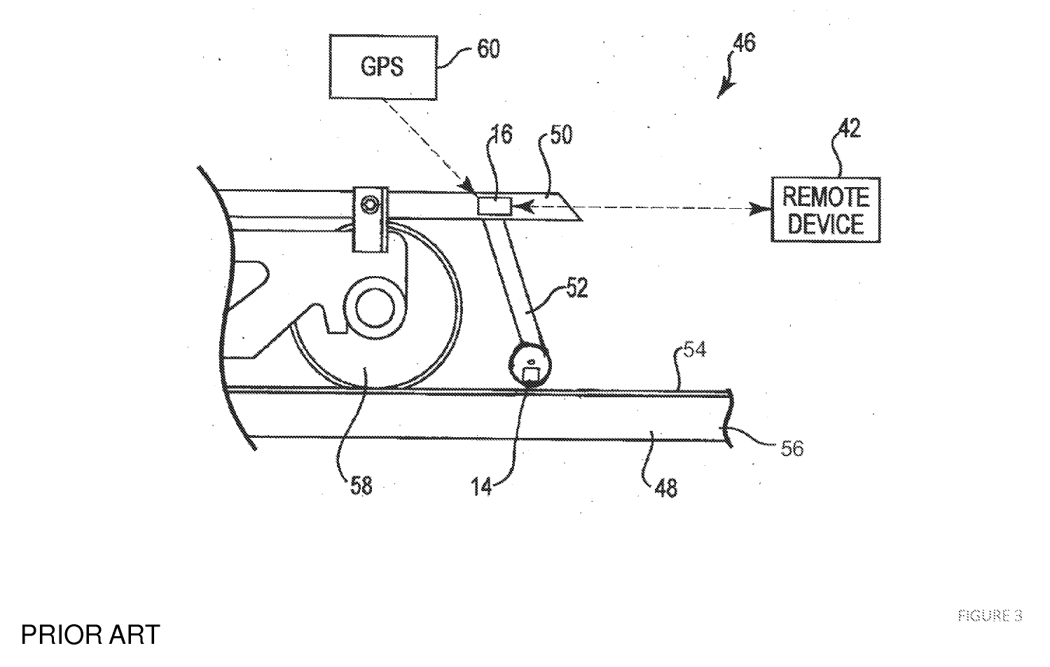

FIG. 3 is a schematic view of an example system 46 for ultrasonically analyzing the microstructural properties of a railroad rail 48. FIG. 2 may represent, for example, an implementation of the system 10 of FIG. 2 for measuring temperature-induced longitudinal stresses in a sample of continuous welded rail (CWR). In the exemplary embodiment of FIG. 3, the ultrasonic sensor unit 14 is coupled to a railcar 40 via a boom and rotating wheel assembly 52, and is configured to transmit ultrasonic waves into a portion of the rail 48 such as the head 54 or web 56. In other embodiments, the ultrasonic sensor unit 14 can be coupled to other locations on the railcar 50, including one of the wheels 58. In some embodiments, multiple ultrasonic sensor units 14 can be coupled to the railcar 50, and can be configured to sense different locations along the same rail 48 or along both rails 48. In some embodiments, for example, a first ultrasonic sensor unit 14 is tasked to obtain ultrasonic backscatter measurements along a first rail and a second ultrasonic sensor unit 14 is tasked to obtain ultrasonic backscatter measurements along the other rail. Multiple ultrasonic sensor units 14 can be employed to measure different locations along the same rail, such as the rail web and head. Other configurations are also possible.

During movement of the railcar 50 along the rail, the ultrasonic sensor unit 14 transmits ultrasonic waves into the rail 48 and senses the resultant backscatter waves. This data is then fed to the evaluation unit 16 for analysis. Location data obtained via a GPS system 60 is also received by the evaluation unit 16 and stored along with the backscatter measurements in the recording unit 34. In some embodiments, the raw backscatter data and location data are transmitted wirelessly to a remote device 42, which process the data to determine one or more microstructural properties associated with the rail 48. In other embodiments, the evaluation unit 16 computes one or more microstructural properties associated with the rail 48 and transmits this data to the remote device 42 either in real-time or at a later time for further analysis. In certain embodiments, the evaluation unit 16 is configured to store the raw and processed data in the recording unit 34 and transmit this data to the remote device 42 at periodic intervals and/or upon demand.

FIG. 4 is a schematic view of an example geometrical ultrasonic transducer configuration for generating longitudinal and oblique ultrasonic backscatter in a structural sample. FIG. 4 may represent, for example, an example spatial configuration of the ultrasonic transducers 20, 22, 24 used by the ultrasonic sensor unit 14 of FIG. 2. In the embodiment of FIG. 4, two ultrasonic transducers 20, 22 are oriented at different, oblique angles relative to the incident surface 62 of the structural sample 12, and are configured to generate/detect shear wave ultrasound in the directions indicated generally by arrows 64 and 66, respectively. A third ultrasonic transducer 24, in turn, is oriented normal to the incident surface 62, and is configured to generate/detect longitudinal wave ultrasound in the direction indicated generally by arrow 68. It is important to note that any combination of transmitting and receiving between transducers can occur, such that signal generated by one transducer may be received by one or more other transducers.

In polycrystalline materials such as railroad rail, ultrasonic backscatter typically results from the multitude of reflections and refractions that occur at the grain boundaries due to variations of the single-crystal elastic moduli. The grain boundary is a single-phase interface in which the crystals on each side of the boundary are nearly identical except in their orientation. The scattering of ultrasound in polycrystalline materials is related to the applied stress through the covariance of the elastic moduli of the material. Both normal incidence (i.e., longitudinal) and oblique incidence (i.e., shear) measurements vary with applied stress, although at different degrees of variance based on a function containing several variables. For statistically isotropic distributions of grains, the covariance of moduli can be calculated in closed-form.

In some embodiments, a statistical approach based on diffuse ultrasonic backscatter can be used to obtain information about a material's microstructure, including the presence and location of cracks, voids, inclusions, or other properties that may compromise the strength and fatigue resistance of a structure. Statistical methods can also be used to extract the grain size in metals, where the grain diameter is within an order of magnitude of the ultrasonic wavelength. For a pulse-echo configuration such as that employed by the system 10 of FIG. 2, the evaluation unit 16 can be configured to perform a statistical analysis on the portion of the time domain response that corresponds to different locations within the bulk of the material. In some embodiments, the statistical model takes into consideration the transfer functions of the ultrasonic transducers 20, 22, 24 along with an appropriate time domain scattered response generated from the heterogeneous media to perform the analysis. If a material's spatial microstructural properties are known a priori, the stress field within the material can be deduced from the covariance of the elastic moduli.

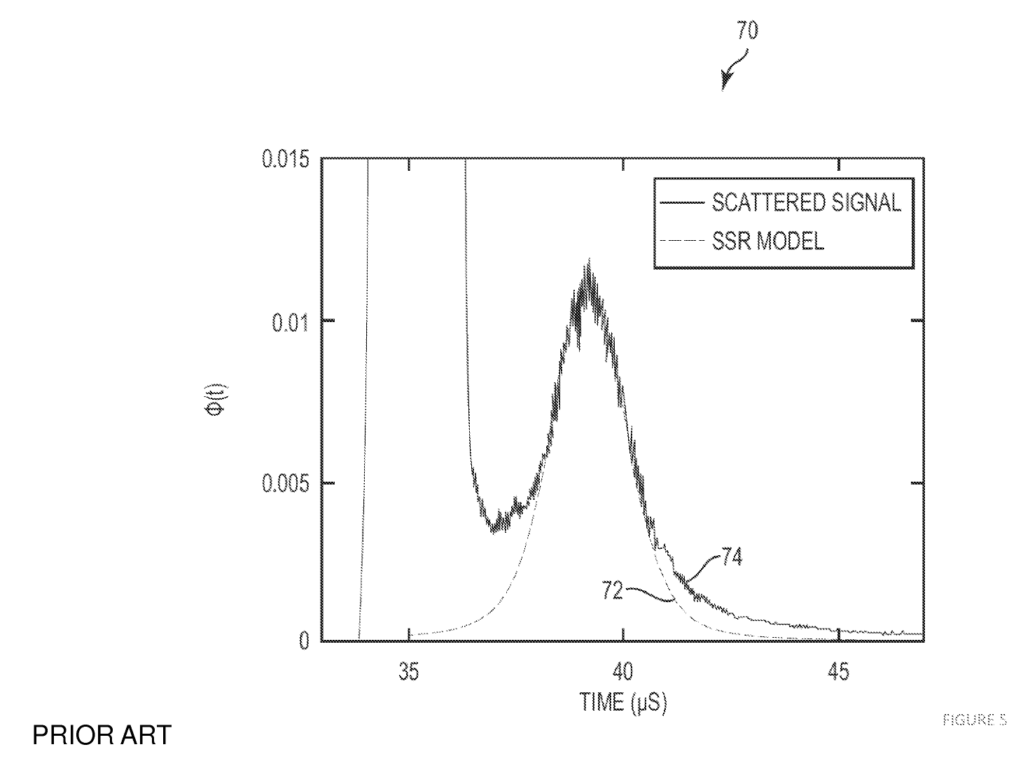

FIG. 5 depicts a graph 70 showing example backscatter response Φ(t) data 72 obtained from a single scattering response (SSR) model compared to experimental waveform data 74 obtained from a steel sample. As is shown in FIG. 5, ultrasonic scattering measurements produce heterogeneous, or “noisy” sample amplitudes from different measurement positions, and the samples from various measurement positions can differ, so to analyze such signals complex statistical methods must be employed, as discussed herein. For a normal incidence configuration in which shear wave energy is lower than the longitudinal modes by several order of magnitude, the SSR model data 72 closely approximates the experimental waveform data during the initial response period (i.e., at about 40 μs) and then deviates from the scattered signal during the latter portion of the response. This deviation can be contributed to higher order scattering effects as increasing times are impacted by multiple scattering.

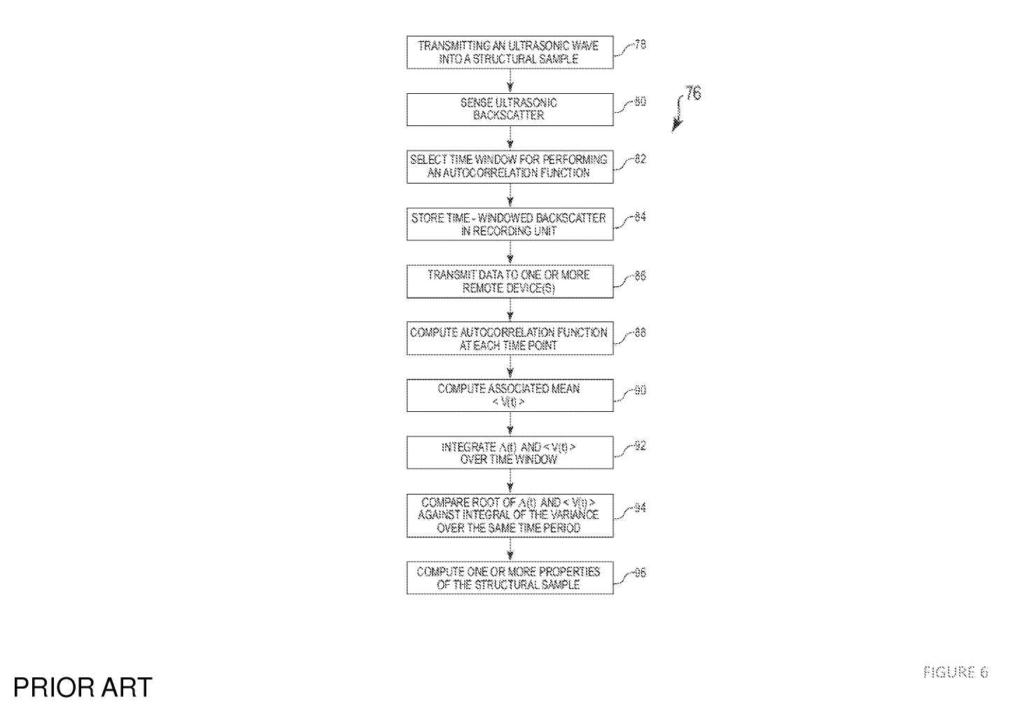

FIG. 6 is a block diagram 76 of an established example method for determining and monitoring changes in microstructural material properties using the system 10 of FIG. 2 and an autocorrelation function. The method 76 may begin generally at block 78 by transmitting an ultrasonic wave into a structural sample 12 to generate ultrasonic backscatter within the sample material. In some embodiments, for example, an ultrasonic sensor unit 14 including multiple ultrasonic transducers 20, 22, 24 each operating in a transmission mode can be used to generate longitudinal and shear waves within the specimen 12 to create measurable ultrasonic backscatter. In some embodiments, the ultrasonic transducers 20, 22, 24 are excited using a Gaussian modulated pulse generated from a pulser/receiver 30 such as the DPR500 available from Imaginant and JSR Ultrasonics of Pittsford, N.Y.

As best shown in FIGS. 2 and 4, in exemplary systems, ultrasonic backscatter data generated by the transmission of ultrasonic waves into the sample is sensed by the ultrasonic transducers 20, 22, 24 operating in a receive mode (block 80). This has been previously described in PCT Application PCT/US2011/062383, published on 7 Jun. 2012 and entitled “System and Method for Ultrasonically Evaluating Structural Properties” which is hereby incorporated by reference. In short, using the backscatter data, the system 10 can compute one or more microstructural material properties of the structural sample (block 96). In some embodiments, for example, the autocorrelated data can be used in conjunction with calibration data to compute the stress and/or strain at each target location on the structural sample as well as determine the location and presence of cracks, voids, inclusions, or other abnormalities. Other characteristics such as stress field gradients within the sample can also be determined using the autocorrelated data.

Previous ultrasonic stress measurement techniques have been attempted, and these techniques were based on wavespeed measurements but have thus far failed because they have low measurement resolutions, require uniform geometries, and are only capable of yielding a relative measurement due to their inability to assess residual stresses. In an attempt to overcome these limitations, exemplary embodiments of the system seek to provide an absolute stress measurement approach based on stress induced microstructural changes without dependence on material geometry.

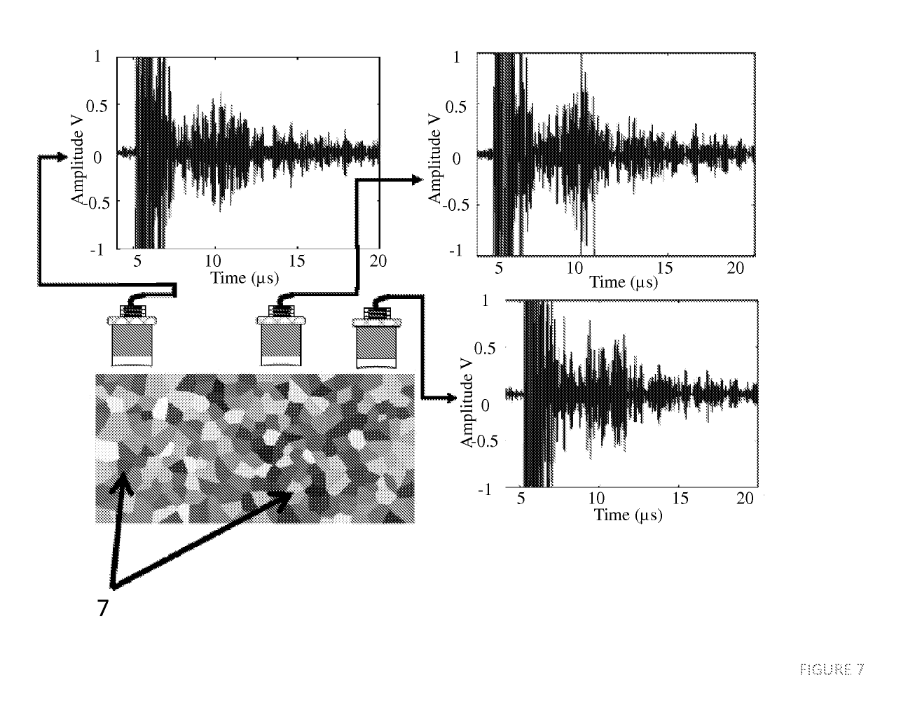

Both longitudinal to longitudinal (L-L), mode-converted longitudinal to transverse (L-T), and shear to shear (T-T) scanning modes can be utilized to investigate the dependence of ultrasonic scattering on the residual stress. The variation of the spatial variance amplitude is quantified after removing the residual stress in a quenched 1080 steel block via annealing with L-L, L-T, and T-T modes. FIG. 7 shows example ultrasonic scattering measurements from polycrystalline material.

A statistical backscatter model was developed to estimate microstructure parameters such as grain size or inclusions and evaluate residual stress. This model depends on what is called the spatial variance. This quantity is experimentally calculated by scanning a material, collecting a number of signals and then subtracting the squared mean signal from the mean squared signal. This establishes how much a single signal varies from the average. In this embodiment, the spatial variance of the signals can be calculated by first determining the spatial average:

$$b ( t ) = \frac{1}{M} {\sum }_{i}^{M} {V}_{i} ( t )$$

Where M is the number of positions and Vᵢ (t) is the measured signal at position i. The spatial variance equation further includes information about the transducer and the material. The spatial variance of the acquired signal can thus be expressed as follows:

$$\begin{matrix}Φ ( t ) = \frac{1}{M} {\sum }_{i - 1}^{M} {( {V}_{i} ( t ) - b ( t ) )}^{2} \\ = < {V}^{2} > - < V {>}^{2}\end{matrix}$$

where V(t) is a matrix of signals acquired at different locations in a conventional ultrasonic C-Scan.

Ideally, materials which have <V>²=0 are used, but this is not always the case. When <V>²=0, the grains are perfectly randomly oriented and have equal grain sizes. The variance calculation <V²>−<V>² relieves the material from these requirements and allows our model to be in good agreement with these non-optimal grain properties. The magnitude of the fluctuations seen in the variance calculation is a function of the number of grains insonified over the cross-sectional area. Ideally, a large number of signals should be collected to minimize the resulting fluctuations. In many practical applications, however, a large scanning area is not always feasible due to material geometry and transducer coupling constraints.

Three focused ultrasonic transducers 20, 22, 24 operating in a pulse/echo configuration and having a geometric configuration such as that shown in FIG. 4 were utilized for measuring ultrasonic backscatter. Since the backscatter coefficients are dependent on the direction of incident ultrasound, different orientations of transducers will be more sensitive to the uniaxial load. Thus, the oblique incidence transducers 20, 22 were oriented at 16-24° from axis 3333 in FIG. 4 and generated shear wave modes (φ_{TT}¹(t)) propagating orthogonally to each other over the cross-section of the sample 12. The normal incidence ultrasonic transducer 24 generated a longitudinal wave mode (φ_{TT}¹(t)) perpendicular to the loading direction. Incident angles from about 16 to 24 degrees can be used to generate mainly shear waves in the material.

The ultrasonic transducers 20, 22, 24 can be mounted onto the sample 12 through a water-filled enclosure, which provides acoustic coupling between the transducer and the sample 12. The distance, or waterpath, between the ultrasonic transducers 20, 22, 24 and the sample 12 was chosen such that each transducer 20, 22, 24 would focus over the same grain volume. The waterpaths of 2.65 inches (6.73 cm) and 2.4 inches (6.11 cm) were used for the oblique ultrasonic transducers 20, 22 and normal incidence ultrasonic transducer 24, respectively. These waterpaths provided a focal depth of approximately 0.16 inches (0.4 cm) into the material. In certain embodiments, differences in longitudinal and shear wave speed can be accounted for, as is known in the art.

Since the scattering can predict the current stress, temperature data can be used to make a proper adjustment to the rail to minimize large temperature gradients leading to critical values of compressive stress. The database on the computer stores the data, including the statistic of wave speed at specific intervals of time as a function of position. The database then compares the current data with previous (and subsequent data) to determine changes, if any, in rail conditions has occurred. The goal is to have a system which provides information of the structural integrity of every location along the track. It often is not adequate to make only local measurements since locations as close as 50 feet away could be in a completely different structural state.

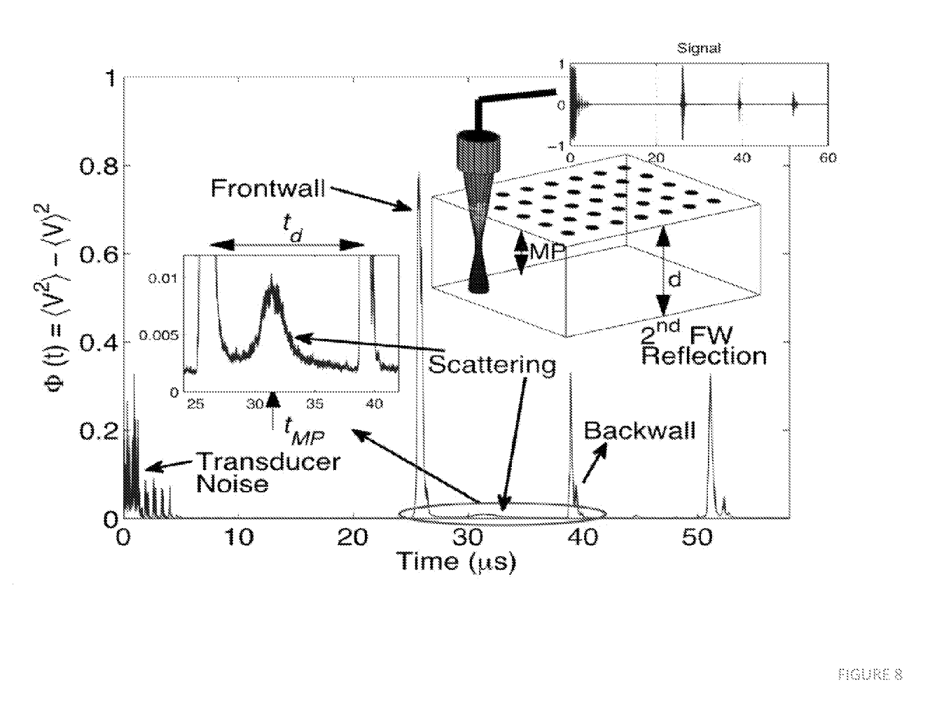

FIG. 8 depicts a clear scattering peak according to:

φ(t)=<V²>−<V>²

This peak was theoretically modeled by equations discussed herein at Equation (1), which includes several individual components. As described further herein, the second term defines the input Gaussian beam characteristics when the transducer is excited by a pulse, while the first term contains the stress dependence and specifically the stress dependent covariance tensor which will be defined herein.

A modeled coefficient was derived by establishing coefficients to account for the noise and micro structural/material properties:

$${Φ}_{LL}^{1} ( t ) = {φ}_{0} [ \frac{π}{2} \frac{{ω}_{0}^{4}}{{c}_{L}^{8}} {\tilde{n}}_{LL} ( L ) {Θ}_{… ijkl}^{… αβγδ} ( T ) ] exp [ - \frac{{t}^{2}}{{σ}^{2}} ] {\int }_{- ∞}^{∞} ( \frac{{w}_{0}^{2}}{{w}^{2} ( z )} ) exp ( - 4 z \frac{{c}_{L} t - z}{{σ}^{2} {c}_{L}^{2}} - 4 {α}_{L} z ] d z \qquad ( 1 )$$

where: ñ_{LL} comprises a spatial correlation function, which is a microstructural property;
Ξᵢⱼₖₗ^{αβγδ} comprises a covariance tensor, a material property;
ñ_{LL}(L)Ξ_{. . . ijkl}^{. . . αβγδ}(T) comprises a stress-dependent backscatter coefficient; and

$$exp [ - \frac{{t}^{2}}{{σ}^{2}} ] {\int }_{- ∞}^{∞} ( \frac{{w}_{0}^{2}}{{w}^{2} ( z )} ) exp [ - 4 z \frac{{c}_{L} t - z}{{σ}^{2} {c}_{L}^{2}} - 4 {α}_{L} z ] d z$$

comprises input wave and transducer beam characteristics.

Thus, a theoretical stress-dependent backscatter coefficient is given as:

$${Φ}_{LL}^{1} ( t ) = [ {\tilde{η}}_{LL} ( L ) {Θ}_{… ijkl}^{… αβγδ} ( T ) ] exp [ - \frac{{t}^{2}}{{σ}^{2}} ]$$

From this equation, the transducer properties can later be canceled out, leaving the terms which deal with the grain size and residual stress. A spatial correlation function is defined as:

$${\tilde{n}}_{LL} ( L ) = \frac{{L}^{3}}{{{π}^{2} [ 1 + {( \frac{4 π f}{{c}_{L}} L )}^{2} ]}^{2}}$$

where L is the average grain size. This is frequency-dependent and grain-size dependent. The frequency dependence is known.

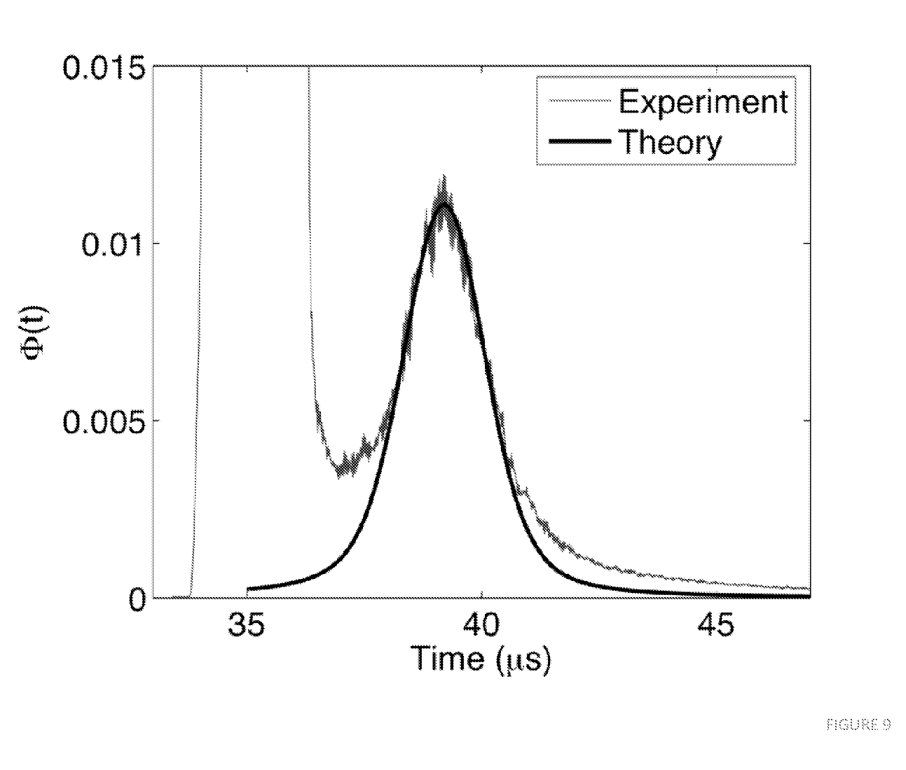

Incorporation of the theoretical spatial variance is shown in FIGS. 9-10. Again, by way of example, the experimental results can be thought of as a Gaussian pulse modified by a stress-dependent term and a factor related to the grain size. This description yields the model to establish a measurement of the residual stress.

FIG. 10 shows theoretical plots predicted for steel and aluminum for the scattering amplitude as a function of stress for different types of transducer combinations wherein 3333/1111 represents longitudinal to longitudinal scattering, and 2323/1313 represents shear to shear scattering. Again, each of the curves is given by transducers receiving from one another and measuring different stress states.

The pre-existing model for the stress dependent amplitude coefficient is predicted to vary quadratically with stress. The load-dependent effective elastic moduli Gᵢⱼₖₗ for a single crystal in terms of the second and third-order elastic moduli can thus be expressed as:

$${G}_{ijkl} = {C}_{ijkl} + ( {δ}_{jl} {δ}_{kP} {δ}_{iQ} + 2 {C}_{ijkr} {S}_{lrPQ} + {C}_{ijklmn} {S}_{mnPQ} ) {T}_{PQ}$$

$$\begin{matrix}{Θ}_{… ijkl}^{… αβγδ} ( T ) = 〈 {G}_{ijkl} {G}_{αβγδ} 〉 - 〈 {G}_{ijkl} 〉 〈 {G}_{αβγδ} 〉 \\ = {K}_{0} + {K}_{1} T + {K}_{2} {T}^{2}\end{matrix}$$

### Where:

T_{PQ} is the stress tensor;
Cᵢⱼₖₗₘₙ is the sixth-rank tensor defining the third-order elastic moduli;
Cᵢⱼₖₗ is the second order elastic moduli tensor; and
Sᵢⱼₖₗ=Cᵢⱼₖₗ is the second-order compliance tensor. The last equation is derived when considering a specific case of loading such as uniaxial stress developed in rail. Each of Kᵢ are material dependent coefficients and K₀ is the stress-free coefficient for the desired loading case.

Residual stress measurements can be taken from two distinct transducers oriented in the same direction to isolate two different variables, grain size, L, and stress, T. Given that the two transducers have different spatial variance they are given by the present system as:

Transducer(f₁)→φ_{LL}¹(t)=ñ_{LL}(L,f₁)Ξ₁₁₁₁¹¹¹¹(T) . . . ×o(z,t)

Transducer(f₂)→φ_{LL}²(t)=ñ_{LL}(L,f₂)Ξ₁₁₁₁¹¹¹¹(T) . . . ×o(z,t)

where it is assumed that the grain size, L, is a constant of the material and can be equally measured with either transducer.

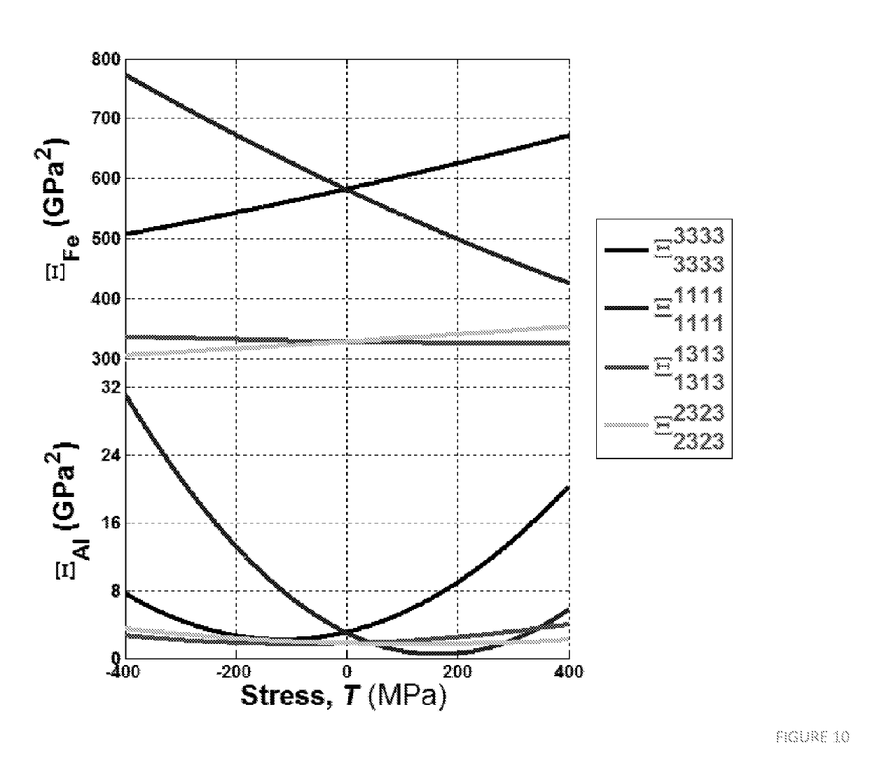

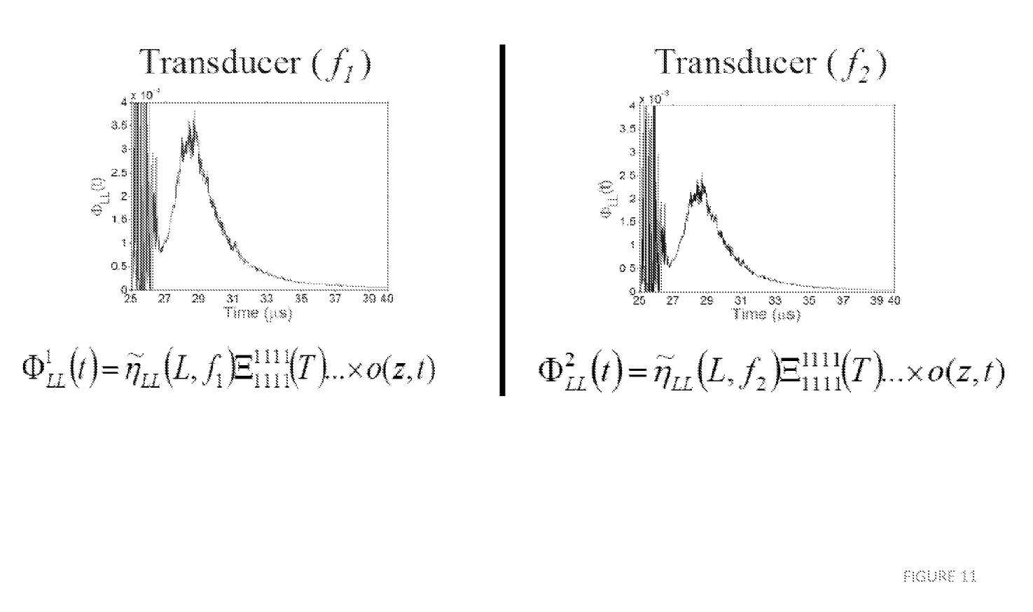

FIG. 11-12 depict actual measurements taken by the distinct transducers. As shown, two immersion transducers (as previously described) at 7.5 MHz and 10 MHz were used. Locations along the symmetry axis at a fixed waterpath were scanned (FIG. 18). An ultrasonic focus was set at 8 mm into the rail, such that the backscatter signals reach a maximum at the corresponding time. The results of the 10 MHz and 7.5 MHz transducers are shown in FIG. 11-12. By evaluating the ratio of the responses:

$$\frac{{Φ}_{LL}^{1 , exp} ( t ) = {\tilde{n}}_{LL} ( L , {f}_{1} ) {Θ}_{1111}^{1111} ( T ) … \times o ( z , t )}{{Φ}_{LL}^{2 , exp} ( t ) = {\tilde{n}}_{LL} ( L , {f}_{2} ) {Θ}_{1111}^{1111} ( T ) … \times o ( z , t )}$$

the stress dependent term can be isolated:

Ξ₁₁₁₁¹¹¹¹(T) . . . ×o(z,t)

thus leaving only a term that identifies the correlation length,

$$\frac{{Φ}_{LL}^{1 , exp} ( t ) = {\tilde{n}}_{LL} ( L , {f}_{1} )}{{Φ}_{LL}^{2 , exp} ( t ) = {\tilde{n}}_{LL} ( L , {f}_{2} )} ≡ A$$

and yielding an approximation of grain size:

$$L = \frac{{c}_{L}}{4 π} \sqrt{\frac{\sqrt{A - 1}}{{f}_{2}^{2} - \sqrt{A} {f}_{1}^{2}}}$$

Having established L, that value can be substituted into either previously presented model presented by Turner and Ghoshal, (2010), φ_{LL}^{1,2}(t) and solve for T:

$$T = \frac{{K}_{1}}{2 {K}_{2}} + \frac{\sqrt{{K}_{1}^{2} - 4 ( {K}_{0} - {Θ}^{exp} ) {K}_{2}}}{2 {K}_{2}}$$

thus solving for both grain length, L, and stress, T.

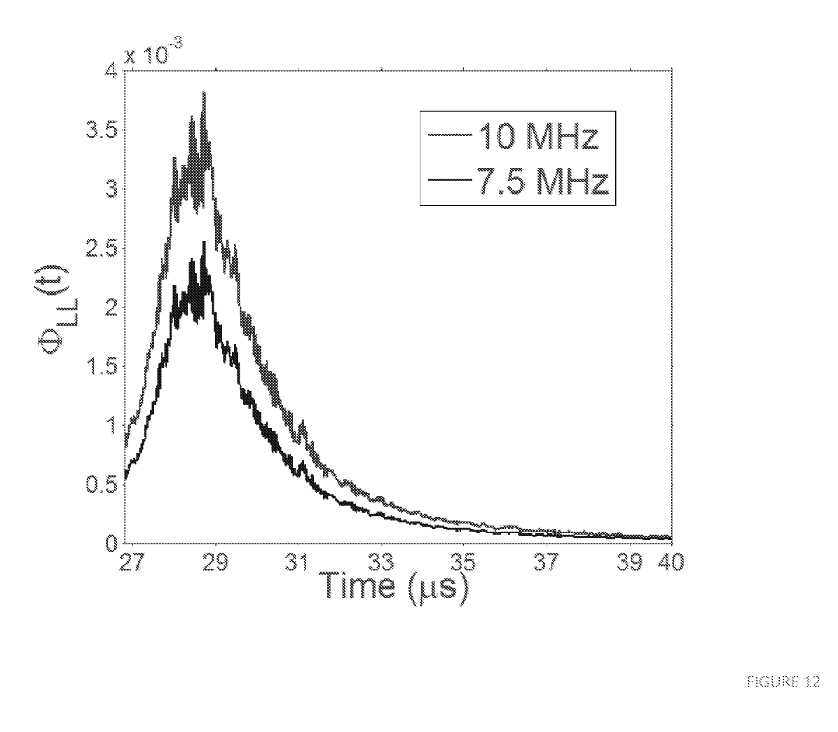

FIG. 13 shows the calculated variance of the collected waveforms. The peak response of the variance curves was then evaluated, and the grain size L and stress T were established, according to the method described herein. The compression stress profile was then established.

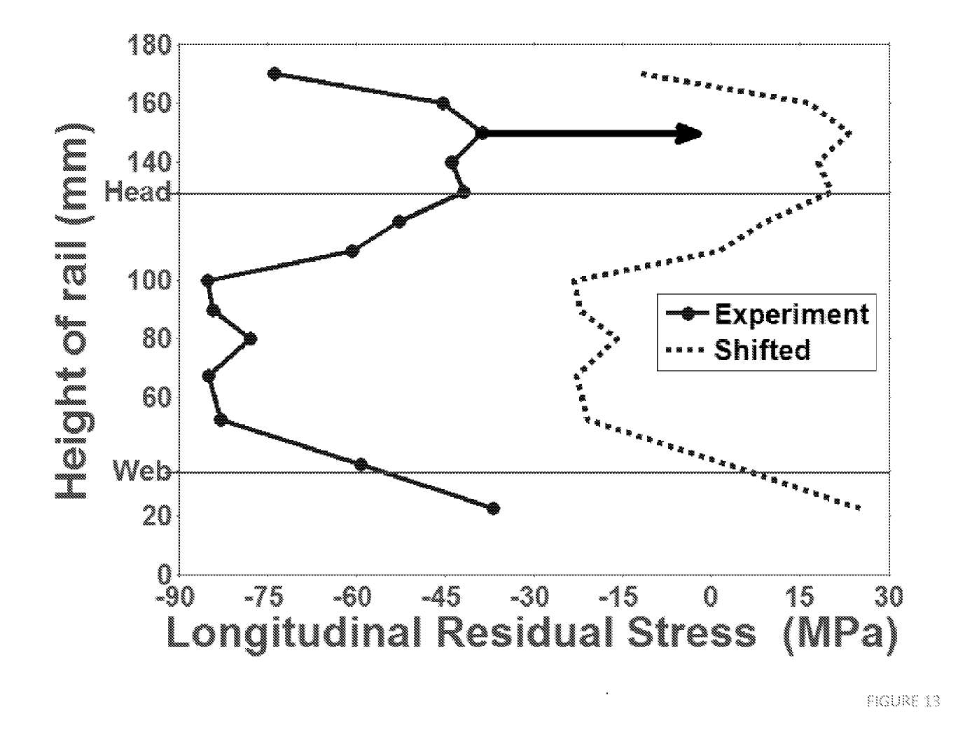

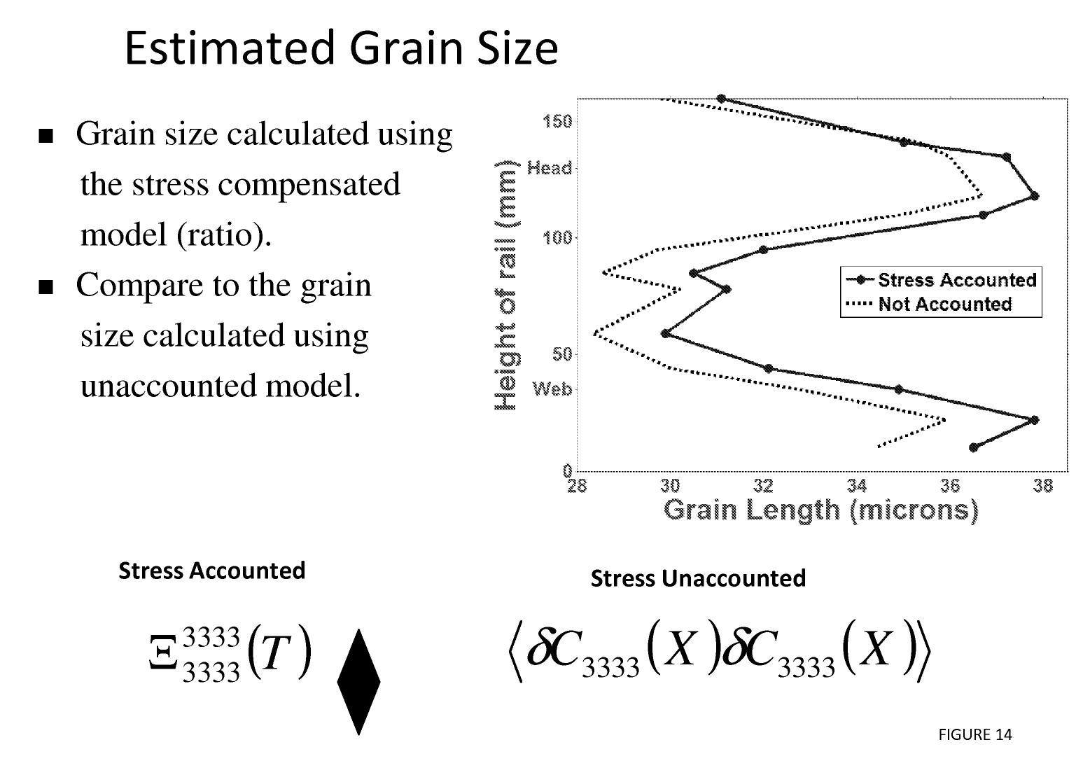

FIG. 14 depicts the estimated grain size (calculated using the stress compensated model method described herein) compared with the grain size calculated using a prior art model in which no residual stress correction is made. Stress accounted for being defined as Ξ₃₃₃₃³³³³(T) and it not being accounted for being defined as: <δC₃₃₃₃(X)δC₃₃₃₃ (X)>.

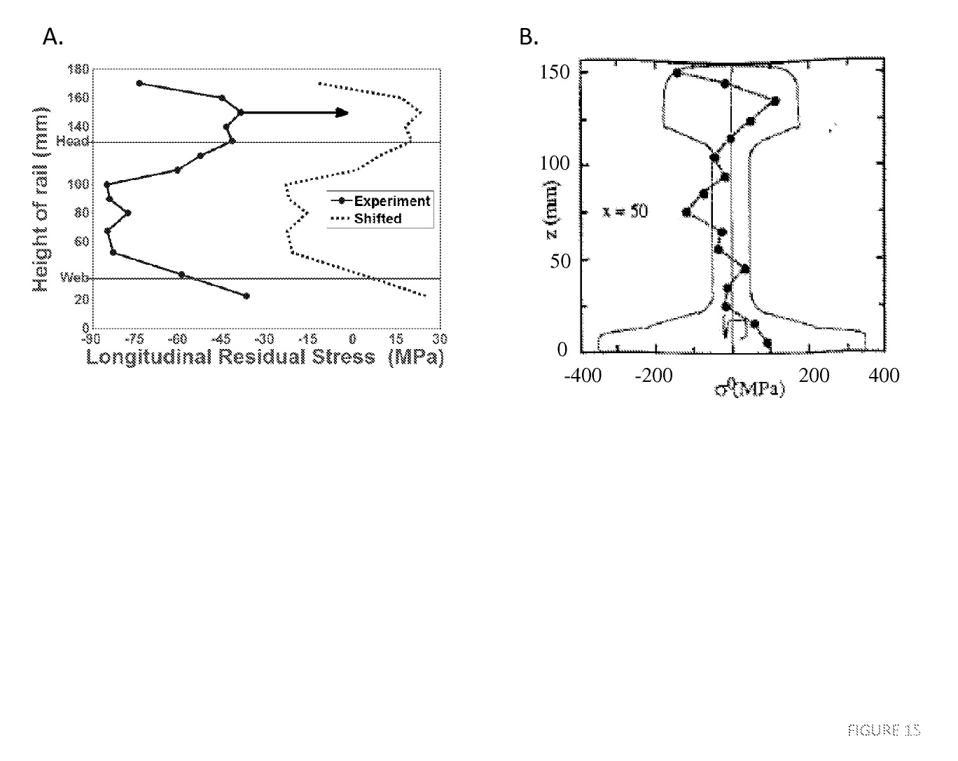

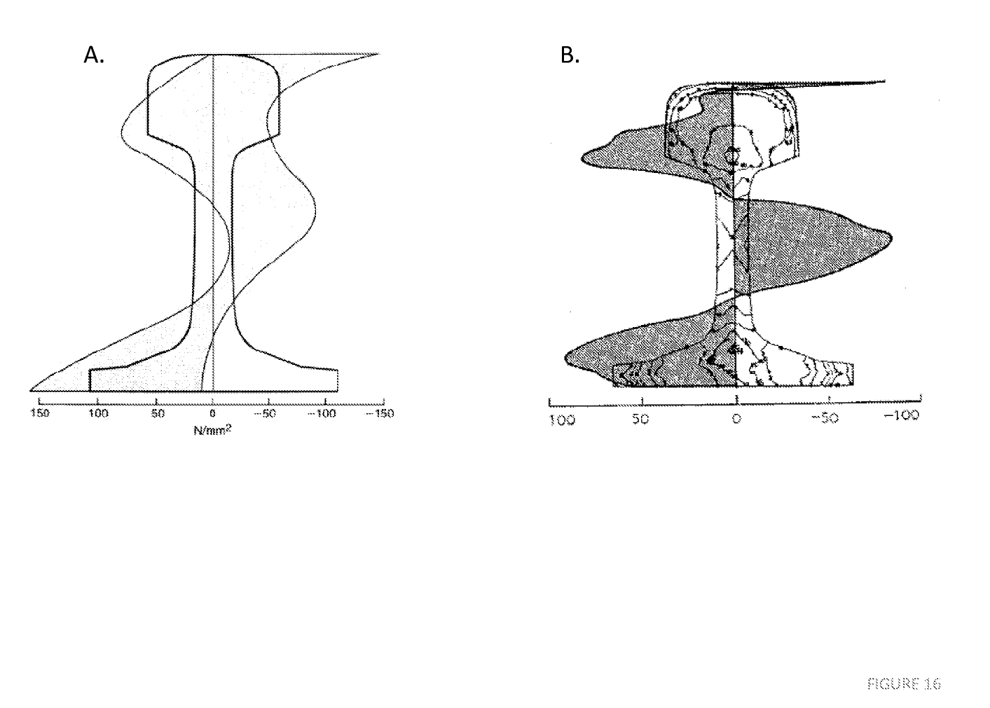

FIG. 15A-D depict the longitudinal residual stress results obtained using certain embodiments of the present method (FIG. 15A) and other prior art techniques, including neutron diffraction (FIG. 15B), X-Ray diffraction (FIG. 15C), and finite element (FIG. 15D) methods. It is clear from this comparison that the present system and method can accurately assess the longitudinal residual stress.

I claim:

1. A system for determining and monitoring microstructure properties of a specimen, comprising:
a. a plurality of transducers each configured to transmit and receive ultrasonic waves to a specimen;
b. a processor configured to calculate a microstructural property value from the received ultrasonic signals.

2. The system of claim 1, wherein the microstructure property of the specimen is selected from the group of material properties consisting of: residual stress, grain size, tension, grain elongation, texture, and porosity.

3. The system of claim 1, further comprising a database configured to store the residual stress values.

4. The system of claim 1, wherein at least one transducer is oriented at an angle of between about 0 degrees to 33 degrees.

5. The system of claim 1, wherein the scattered ultrasonic signal received by each transducer comprises both longitudinal and shear waves.

6. The system of claim 1, further comprising a processor configured to calculate the spatial variance value from the scattered ultrasonic signals as a function of time.

7. The system of claim 1, wherein the specimen is a rail.

8. A method for ultrasonic inspection of a specimen, comprising:
a. transmitting ultrasonic waves from a plurality of transducers to a location on a specimen;
b. receiving a scattered ultrasonic signal on each transducer in response to the transmitted ultrasonic waves;
c. digitizing the scattered ultrasonic signal received by each transducer; and
d. determining a residual stress value from the scattered ultrasonic signals.
